(19) United States
(12) Patent Application Publication
(10) Pub. No.: US 2026/0260414 A1
(43) Pub. Date: Sep. 3, 2026

(54) SYSTEM AND METHOD FOR DECODING TRANSPARENCY INFORMATION IN REAL-TIME FOR BLENDED VIDEO CONTENT

(71) Applicant: Flying Flamingos India Private Limited, Bangalore (IN)

(72) Inventors: Amit Gaiki, Bangalore (IN); Shourya Agarwal, Ajmer (IN); Shubham Shukla, Bengaluru (IN)

(73) Assignee: Flying Flamingos India Private Limited, Bangalore (IN)

(21) Appl. No.: 19/539,330

(22) Filed: Feb. 13, 2026

(30) Foreign Application Priority Data
Feb. 13, 2025 (IN) 202541012144

(51) Int. Cl. G06T 15/00; G06T 3/4038; G06T 9/00; G06T 15/50; G06T 19/00

(52) U.S. Cl. CPC G06T 15/005; G06T 3/4038; G06T 9/00; G06T 15/503; G06T 19/006; G06T 2210/62

(57) ABSTRACT

The present disclosure relates to a system, method and a non-transitory computer-readable medium storing instructions that, when executed by one or more processors, cause a system to perform a method for decoding and rendering transparency information from stitched video content on a communication device. The system includes a receiving module that acquires a stitched video containing a base and a mask segment, a decoding module that processes both segments as a single unified stream, and a shader module that extracts luminance-based alpha values through GPU acceleration. A compositing module applies the extracted alpha values to the corresponding base pixels to generate a blended frame, and a display module renders the frame on the communication device in real time. An optimization module monitors performance parameters and dynamically adjusts resolution, bitrate, and rendering configurations to maintain transparency fidelity and smooth playback. The system provides a single-decoder, GPU-assisted framework that enables seamless integration of transparent video content with real or virtual backgrounds.

### CROSS-REFERENCE TO RELATED APPLICATIONS

The present application claims the benefit of Indian Provisional Patent Application No. 202541012144, filed Feb. 13, 2025, all of which are hereby incorporated by reference in their entirety for all purposes.

### TECHNICAL FIELD

The present disclosure relates generally to the field of digital video processing and rendering. More particularly, the present disclosure relates to a system and a method for decoding and rendering alpha channel transparency in video content.

### BACKGROUND

Most mobile and mixed reality (MR) platforms support native decoding of RGB video streams but lack support for decoding an alpha channel that represents transparency. Conventional approaches require either a four-channel RGBA format or complex shader pipelines that are incompatible with standard video decoders. Consequently, videos containing transparent overlays or composited graphics appear with opaque or black backgrounds when rendered on mobile devices. Some techniques attempt to transmit separate mask videos representing transparency information. However, decoding two videos independently often results in frame de-synchronization, increased latency, and device-specific incompatibilities. Other approaches employ custom encoding formats, which break compatibility with standard playback libraries.

Therefore, there exists a need for a unified and hardware-agnostic technique that allows decoding of transparency information using a single, standard video decoder without modifying the native decoding framework.

### SUMMARY

In an aspect, the present disclosure provides a system for decoding and rendering transparency information from stitched video content. The system includes a receiving module configured to receive, from a user device, a stitched video. The stitched video includes a base video segment and a mask video segment arranged in a pre-determined orientation. The system includes a decoding module configured to decode, using a single-decoder pipeline, the stitched video to separate the base and mask segments. The system includes a shaded module configured to extract luminance values from the mask to compute corresponding alpha values. The system includes a compositing module configured to composite the base data and alpha data to generate an RGBA frame. The system includes a display module configured to display, using a display interface, the final blended frame in real time on the user device. Further, the system may include an optimization module configured to perform adaptive optimization to maintain frame-synchronized decoding, efficient GPU processing, and consistent transparency rendering quality across varying device and network conditions.

In an embodiment of the present disclosure, the stitched composite video is encoded in a standard video container format supporting single-stream decoding selected from MP4, HEVC, or WebM to enable the decoding of the base video segment and the mask video segment decoded using a native hardware decoder of the communication device.

In an embodiment of the present disclosure, the stitched video is arranged in a top-down or left-right configuration. The configuration enables each pixel of the base video segment to maintain pixel-level correspondence with a luminance-defining pixel of the mask video segment within the same decoded frame.

In an embodiment of the present disclosure, the shader module executes a GPU-accelerated shader pipeline. The shader pipeline includes at least one OpenGL shader or equivalent programmable graphics shader to convert grayscale luminance values into normalized alpha coefficients in real time.

In an embodiment of the present disclosure, the compositing module performs GPU-accelerated per-pixel alpha blending using parallel fragment execution and sub-pixel correction to preserve edge fidelity and transparency gradients within the final blended frame.

In an embodiment of the present disclosure, the display module overlays the final blended frame onto a background scene captured by one or more sensors of the communication device to enable rendering within an augmented-reality or mixed-reality environment.

In an embodiment of the present disclosure, the system further includes an optimization module configured to dynamically regulate at least one of decoding throughput, GPU utilization, playback resolution, or frame rate. The optimization module maintains real-time transparency rendering across heterogeneous device capabilities and network conditions.

In an embodiment of the present disclosure, the system further includes a repository configured to store at least one of adaptive bitrate parameters, frame buffering rules, or playback optimization instructions. The repository is accessed by the receiving module to minimize frame-latency drift between the base video segment and the mask video segment.

In an embodiment of the present disclosure, the system generates and processes metadata describing alpha-map boundaries, segment orientation, and pixel correspondence. The system uses the metadata to enable at least one of selective region-based decoding, compression optimization, or error-resilient transparency rendering.

In another aspect, the present disclosure provides a computer-implemented method for decoding and rendering transparency information from stitched video content. The computer-implemented method includes a first step of receiving, using a receiving module, a stitched video from a user device. The stitched video includes a base video segment and a mask video segment arranged in a predetermined orientation. The computer-implemented method includes a second step of decoding, using a decoding module, the stitched video to extract the base and the mask video segments as synchronized pixel-aligned frames. The computer-implemented method includes a third step of extracting, using a shader module, transparency information from luminance values of the mask segment and convert the luminance information into normalized alpha values. The computer-implemented method includes a fourth step of blending, using a compositing module, the extracted alpha values with corresponding pixels of the base segment to generate an RGBA frame. The computer-implemented method includes a fifth step of displaying, using a display module, the final blended frame on a display interface of the user device in real time.

In yet another aspect, a non-transitory computer-readable medium is disclosed. The non-transitory computer-readable medium stores instructions that, when executed by one or more processors, cause a system to perform a method for decoding and rendering transparency information from stitched video content. The method includes a first step of receiving, using a receiving module, a stitched video from a user device. The stitched video includes a base video segment and a mask video segment arranged in a predetermined orientation. The method includes a second step of decoding, using a decoding module, the stitched video to extract the base and the mask video segments as synchronized pixel-aligned frames. The method includes a third step of extracting, using a shader module, transparency information from luminance values of the mask segment and convert the luminance information into normalized alpha values. The method includes a fourth step of blending, using a compositing module, the extracted alpha values with corresponding pixels of the base segment to generate an RGBA frame. The method includes a fifth step of displaying, using a display module, the final blended frame on a display interface of the user device in real time.

In an embodiment of the present disclosure, the instructions cause generation and processing of metadata defining alpha-map boundaries and segment orientation to enable selective region-based decoding or error-resilient rendering.

### BRIEF DESCRIPTION OF DRAWINGS

For a better understanding of the various described embodiments, reference should be made to the Detailed Description below, in conjunction with the following drawings in which like reference numerals refer to corresponding parts throughout the figures.

FIG. 1A illustrates a schematic block diagram of a computing environment implementing a system for decoding and rendering transparency information from stitched video content, in accordance with various embodiments of the present disclosure;

FIG. 1B illustrates a flowchart representing a method implemented using functional modules of the system of FIG. 1A for decoding and rendering the transparency information from the stitched video content on a communication device in accordance with various embodiments of the present disclosure;

FIG. 2 illustrates a sequence of visual frames representing the progressive transformation of stitched video content into a final blended output, in accordance with various embodiments of the present disclosure; and

FIG. 3 illustrates a block diagram of a device, in accordance with various embodiments of the present disclosure.

In accordance with common practice, the various features illustrated in the drawings may not be drawn to scale. Accordingly, the dimensions of the various features may be arbitrarily expanded or reduced for clarity. In addition, some drawings may not depict all the components of a given system, method, or device. Finally, like reference numerals may be used to denote features throughout the specification and figures.

### DETAILED DESCRIPTION

In the following description, for the purposes of explanation, various specific details are set forth to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. Various changes may be made in the function and arrangement of elements without departing from the spirit and scope of the disclosure as set forth.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” or “an implementation” or “one implementation” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the features, structures, or characteristics may be combined in any suitable manner in one or more embodiments.

The terminology used herein is for the purpose of describing embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure relates to a method and system for decoding and rendering transparency information from stitched video content. The method and the system enable real-time rendering of transparency information, allowing video content to blend seamlessly with the surrounding environment. This enables a high-fidelity, visually integrated viewing experience where virtual or digital video content appears naturally composited within real-world or mixed-reality (MR) scenes.

The decoding and rendering transparency information from stitched video content refers to a process in which a single video stream, containing both the base visual content and its corresponding mask or transparency data, is decoded and processed to extract per-pixel transparency information. The base video segment contains the primary RGB visual data and the mask video segment contains luminance-based information representing the transparency or alpha values of each pixel. The mask segment defines which portions of the base video are visible, semi-transparent, or invisible and enables precise compositing of layered video imagery. In the present disclosure, a base video segment and a mask video segment are encoded adjacently within each frame of the stitched video, arranged in a top-down (TD) or left-right (LR) orientation based on the encoding preference. Such structural arrangement maintains frame-level synchronization and pixel-wise alignment between the visual color data and the corresponding transparency data. The stitched configuration further enables the use of existing hardware decoders to process the entire video as a single file, thereby eliminating the need for dedicated multi-stream decoding mechanisms or specialized alpha-channel processing hardware.

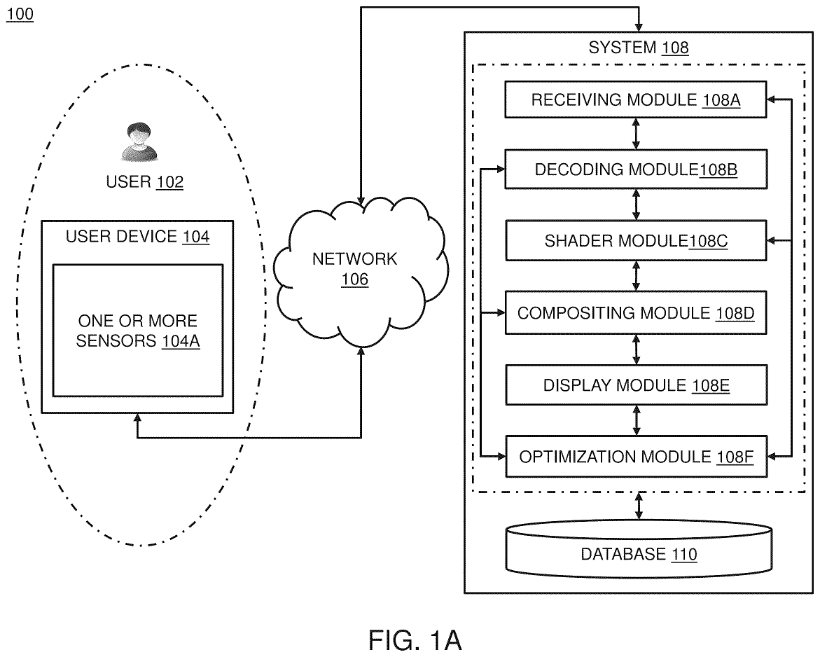

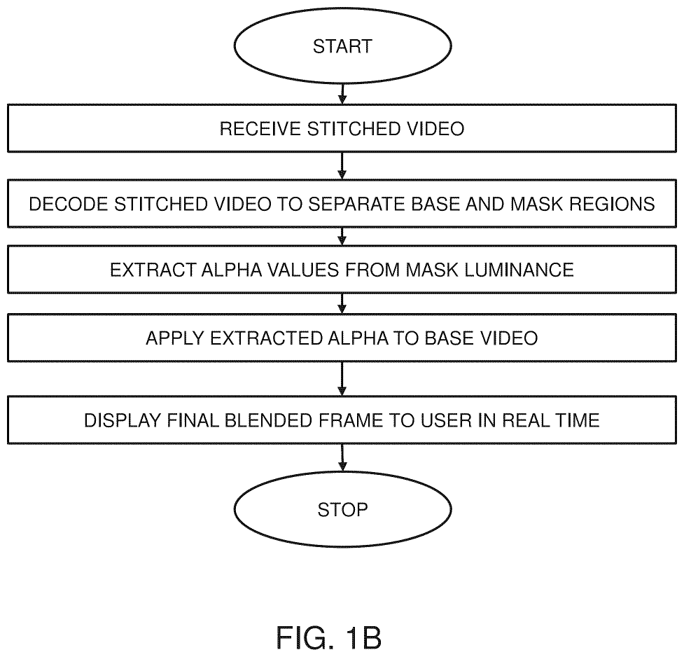

FIG. 1A illustrates a schematic block diagram of an exemplary computing environment 100 implementing a system 108 for decoding and rendering transparency information from stitched video content, in accordance with various embodiments of the present disclosure. The exemplary computing environment 100 includes a communication device 104 associated with a user 102 and equipped with one or more sensors 104a. In addition, the computing environment 100 includes a network 106, a system 108 for decoding and rendering transparency information, and a repository 110. The computing environment 100 provides a computing framework that supports acquisition, transmission, decoding, and real-time visualization of stitched video streams that contain embedded transparency or alpha-channel data. In some embodiments, the computing environment 100 supports synchronized video streams carrying base segments and transparency segments, metadata descriptors, or stitched-frame inputs. The segments, descriptors or inputs may be used for keypoint analysis and transparency-aware tracking.

The computing environment 100 enables seamless playback of transparent video overlays across diverse applications. Examples of the applications may include augmented-reality visualization, e-commerce product rendering, interactive digital media, and the like. The computing environment 100 enables integration of decoding, transparency extraction, and compositing within the unified system 108. The computing environment 100 allows alpha-encoded video elements to blend naturally with real-world imagery or digital scenes through the integration. Accordingly, the computing environment 100 enables maintenance of spatial consistency and visual fidelity during playback.

The user 102 interacts with the communication device 104 to view or present video content that contains transparency information. The communication device 104 captures live imagery and plays back stitched video streams through the system 108. The user 102 may be an operator, consumer, or developer interacting with transparent video overlays that appear integrated with the surrounding environment. The communication device 104 serves as the user's access point for executing the decoding and rendering process implemented by the system 108. The communication device 104 may include an intelligent frame buffer to temporarily store paired color and mask regions before local processing or transmission.

The communication device 104 is a computing platform configured to process stitched video data, extract transparency information, and display composited visual frames in real time. Examples of the communication device 104 include smartphones, tablets, head-mounted displays, projection-based visors, or portable media players equipped with modern graphics hardware. The communication device 104 executes one or more software or firmware components that form part of the system 108. In an embodiment, the communication device 104 may include an intelligent frame buffer to temporarily store paired color and mask regions before local processing or transmission.

The one or more sensors 104a are integrated within or coupled to the communication device 104. The one or more sensors 104a capture environmental imagery and contextual inputs. The one or more sensors 104a may include an RGB camera for capturing live background imagery, a depth sensor for determining spatial distance, or an ambient-light sensor for adaptive brightness adjustment, or IMU. In mixed-reality use-cases, the one or more sensors 104a may supply live camera feeds and environmental cues used to composite the stitched-video frames with background scenes. The one or more sensors 104a provide positional data used to anchor transparency-decoded video frames within the physical scene. Further, the one or more sensors 104a provide contextual data that allows the communication device 104 to render transparency-enabled video over live background imagery. Each stitched frame may carry metadata such as orientation, frame index, codec profile, stitching orientation (top-down or left-right), and timestamp to enable deterministic alignment and decoding. The system 108 receives the stitched frames that contain a base video segment and a mask video segment arranged in a pre-determined orientation such as top-down or left-right. Each stitched frame embeds the color and mask regions in exact pixel alignment to preserve frame-accurate correspondence.

The network 106 provides communication connectivity between the communication device 104, content repositories and the system 108. The network 106 may include one or more wired links such as Wi-Fi, 5G, LTE, or wired links. The network 106 supports the streamed stitched-video delivery and content fetch from remote repositories. Network packets and streaming manifests can carry signed metadata fields and container-level tags. The metadata fields and the container-level tags instruct the system 108 on stitched orientation, alpha mapping profile, and expected data format (for example, MP4/H.264 stitched, WebM/HEVC native-alpha).

Further, the network 106 supports high-throughput transfer of stitched video streams, transparency metadata, and adaptive bitrate control signals between the communication device 104 and the system 108. The network 106 ensures that transparency-encoded frames remain synchronized across distributed playback or collaborative rendering environments. Network packets and streaming manifests can carry signed metadata fields and container-level tags. The packets and manifests may instruct system modules on stitched orientation, alpha mapping profile, and expected data format (for example, MP4/H.264 stitched, WebM/HEVC native-alpha). The system 108 supports industry-standard containers and codecs (for example MP4 with H.264 or H.265, WebM with VP9, or HEVC with alpha) to ensure compatibility with native hardware decoders on target devices.

The system 108 is a computing entity that executes the alpha decoding and rendering pipeline. The system 108 may operate on-device as a local runtime, at an edge node, or in the cloud. The system 108 coordinates reception, decoding, alpha extraction, compositing, and adaptive optimization to produce a final blended frame for display on the communication device 104. The system 108 decodes the stitched video streams, extracts alpha information, and renders the transparent video frames based on the extracted transparency information contained within the stitched video frames. The system 108 coordinate's data reception, frame decoding, alpha extraction, compositing, and display control to produce transparency-corrected visual output.

The system 108 manages incoming data and maintains frame-level synchronization for decoding and rendering operations. The system 108 buffers incoming stitched frames, verifies frame integrity using frame indices and checksums. In addition, the system 108 requests re-transmission or applies interpolation when frames are missing or corrupted. Also, the system 108 exchanges the stitched frames and decoded buffers annotated with metadata fields to enable deterministic handling and correct compositing. The metadata fields may include frame_index, timestamp, stitched_orientation, codec, and alpha_profile. If mask data is corrupted or missing, the system 108 may use temporal interpolation or conservative compositing until valid alpha data becomes available. The system 108 logs such events and adapts decoding or buffer strategies accordingly.

In one embodiment, the system 108 includes an internal architecture composed of multiple functional modules, such as a receiving module, decoding module, shader module, intelligent frame buffer, compositing module, display module, and optimization module. The modules collectively implement the decoding pipeline for extracting the luminance-based transparency data from a stitched video and blending the result with an underlying scene.

The system 108 implements a single-decoder pipeline that decodes the stitched video as a single continuous stream. The system 108 uses GPU shaders to extract the transparency information from the decoded frames. Further, the system 108 cooperates with the communication device 104 to acquire the stitched video frames either from the local memory or from the remote repository 110. Each stitched video frame may include a base segment and a mask segment. The base segment represents color information. The mask segment represents the transparency data arranged in a top-down or left-right configuration. The system 108 interprets the configuration to maintain pixel-level alignment between the base segment and the mask segment during decoding.

The repository 110 stores encoded stitched videos, transparency metadata, and format descriptors for retrieval and playback. The repository 110 may reside on the communication device 104, within a local server, or in a cloud-hosted database accessible through the network 106. The repository 110 may include stitched files, native-alpha encoded assets, alpha mapping profiles, and metadata descriptors. Also, the repository 110 supports versioning of alpha profiles so devices can select optimal decoding configurations based on device capabilities.

In streaming scenarios, the repository 110 supports adaptive bitrate delivery to accommodate varying bandwidth conditions without interrupting transparency decoding. Further, the repository 110 may archive historical performance profiles that allow the system 108 to select optimal descriptor distributions. The optimal descriptor distributions may be selected adaptively based on device type, network conditions, or environmental context.

The system 108 decodes the stitched video using a unified pipeline that separates luminance-based transparency data from color data. The system 108 extracts alpha values from the decoded luminance region. Further, the system 108 applies the extracted alpha values to the corresponding color region to generate an RGBA output frame. Accordingly, the system 108 renders the blended frame on a display interface of the communication device 104 in real time. The system 108 ensures that transparent regions reveal the live environment or digital background with accurate opacity gradients.

In operation, the environment 100 enables dynamic transparency rendering within diverse usage contexts. In an example implementation, the communication device 104 streams a stitched video containing transparency information. The system 108 decodes each frame of the stitched video, and computes corresponding alpha coefficients for each frame. Accordingly, the system 108 blends the result with the background scene captured by the one or more sensors 104a. The process provides a seamless visual experience where video elements appear integrated within the user's physical surroundings. When image frames contain composite visual channels, the system 108 uses GPU-assisted processing to extract the active channel before descriptor generation to retain alignment accuracy. The visual channels include RGB and luminance masks.

The system 108 performs adaptive control to maintain smooth playback under variable computational or network conditions. The system 108 monitors device performance metrics such as GPU utilization, memory consumption, and decoding throughput. The system 108 utilizes the data associated with the device performance metrics to dynamically adjust video resolution, shader sampling density, or bitrate. The dynamic adjustment is done to preserve visual fidelity and avoid frame drops or de-synchronization.

In an embodiment, the system 108 may employ an intelligent frame buffer that temporarily stores paired color and transparency data for one or more frames. The frame buffer ensures temporal alignment between the two data types and supports corrective interpolation when missing or corrupted transparency information is detected. The mechanism prevents flicker and maintains frame-accurate synchronization during playback. The intelligent frame buffer holds paired RGB and alpha data during the two-pass sequence to guarantee temporal alignment before compositing.

The environment 100 supports both standalone and connected modes. In standalone configurations, the communication device 104 locally performs decoding and compositing operations. In connected configurations, the system 108 offloads portions of the computation to a cloud-based processing node, and the communication device 104 focuses on display rendering and user interaction. The distributed architecture provides scalability and consistent performance across devices with varying processing capabilities.

The environment 100 establishes a foundation for decoding, extracting, and rendering transparency information from stitched video content. The system 108 combines sensor-based contextual awareness, adaptive decoding, and GPU-accelerated compositing to ensure real-time generation of visually coherent alpha-video overlays. The alpha-video overlays may be suitable for mixed-reality, interactive media, and digital-content visualization applications.

The environment 100 supports single-decoder stitched playback. The stitched frame decodes as a single native stream. A GPU shader reads the mask region and converts luminance values to alpha coefficients for immediate compositing. The system 108 annotates each frame with format metadata for selecting the correct extraction routine. In an example, the metadata corresponding to the stitched orientation, color format YUV/NV12, or expected alpha profile.

The environment 100 provides error-handling mechanisms for corrupted or missing alpha data. When a decoded mask region is partially missing or corrupted, the intelligent frame buffer triggers temporal interpolation or requests retransmission via the network 106. The system 108 may mark frame integrity failures in metadata to apply fallback alpha estimation or use previous-frame alpha.

The display interface of the communication device 104 presents the final blended output. The display interface may show the merged video over a live camera feed for AR or as a standalone transparent video over a virtual background for a mixed reality (MR) experience. The display interface accepts blending instructions and alpha mapping profiles passed as metadata with each frame.

The system 108 supports adaptive optimization for heterogeneous devices. An optimization component may monitor GPU load, decoder throughput, and memory pressure and include adaptive controls (for example, downscaling stitched frame resolution, switching to two-pass extraction, or selecting a lower complexity alpha mapping profile) to preserve frame rate and visual fidelity. The optimization component may use metadata telemetry to select the best strategy.

The system 108 enables multi-device synchronization in collaborative scenarios. Multiple devices share time-stamped metadata and alignment information so the same stitched asset plays in a synchronized manner across participants. Shared metadata fields, such as global session time and frame anchor IDs, ensure consistent alpha application across devices. The system 108 provides a metadata-rich, error-resilient, and adaptive framework for delivering stitched alpha video and native alpha assets to a wide variety of devices. The architecture balances single-decoder simplicity to maximize compatibility and visual accuracy.

The number and arrangement of components shown in FIG. 1A are exemplary and may vary depending on implementation. Additional repositories, network layers, or display interfaces may be incorporated to support specific deployment scenarios. Alternatively, the functional blocks of the system 108 may be distributed across multiple computing nodes or integrated within the communication device 104 to optimize performance and resource utilization.

Referring to FIG. 1B, the system 108 includes a plurality of functional modules that collectively perform decoding and rendering of the transparency information from the stitched video content. The plurality of functional modules include a receiving module 108a, a decoding module 108b, a shader module 108c, a compositing module 108d, a display module 108e, and an optimization module 108f. Each of the plurality of functional modules execute program instructions stored in one or more memories and operatively coupled to one or more processors of the system 108. The plurality of functional modules collectively perform the method for decoding and rendering the transparency information from the stitched video content on the communication device 104 FIG. 1B. The method defines a sequential process executed by the system 108 to enable real-time decoding and rendering of the video content containing transparency data embedded within a single stitched video file. The method includes the steps of receiving a stitched video, and decoding the stitched video to separate base regions and mask regions. Next, the method includes the steps of extracting alpha values from mask luminance, applying the extracted alpha to the base video, and displaying a final blended frame on the communication device 104 in real time.

The receiving module 108a is configured to receive the stitched video. The stitched video contains the base video segment and the mask video segment arranged in the pre-determined orientation. The base video segment is a portion of each stitched video frame that carries visual color information encoded as RGB pixel data. The base video segment represents the primary visual content intended to be rendered and displayed, excluding transparency information. The mask video segment is a portion of each stitched video frame that carries grayscale luminance data used to define pixel-level transparency. Grayscale intensity values in the mask video segment encode transparency coefficients applied to corresponding pixels in the base video segment.

The reception of the stitched video corresponds to the first step of the method shown in FIG. 1B. In an embodiment, the pre-determined orientation corresponds to a top-down configuration. In the top-down configuration, the base segments and the mask segments are vertically aligned. In another embodiment, the pre-determined orientation corresponds to a left-right configuration. In the left-right configuration, the base segments and the mask segments are horizontally aligned. The arrangement ensures that every frame within the stitched video maintains pixel-level correspondence between the base segments and the mask segments. The pixel-level correspondence refers to a spatial alignment in which each pixel location in the mask video segment maps directly to a specific pixel location in the base video segment within the same frame. This correspondence ensures that transparency values extracted from the mask video segment apply to the correct color pixels during compositing.

The receiving module 108a acquires the stitched video from local memory, a remote server, or a streaming service. Accordingly, the receiving module 108a prepares the data for decoding and maintains frame order and synchronization. The receiving module 108a interprets container metadata, determines the stitched orientation, and forwards frames downstream. In embodiments, the receiving module 108a validates frame indices, performs buffering, and annotates data streams with the metadata such as timestamp, orientation, and codec profile. The annotation is done to maintain deterministic alignment between the base segments and the mask segments. The receiving module 108a may operate in coordination with the optimization module 108f to regulate bitrate or pre-fetch frames based on network bandwidth.

The receiving module 108a interprets metadata that defines the stitched configuration, frame dimensions, frame rate, and encoding parameters. Based on the metadata, the receiving module 108a processes the stitched video in the correct orientation and maintains spatial and temporal synchronization between the color data and the transparency data. The synchronization ensures that each luminance value in the mask segment directly aligns with a corresponding pixel in the base segment within the same frame. The receiving module 108a parses container metadata and frame indices to buffer the stitched video frames in sequential order and forward complete frames to the decoding module 108b and preserves temporal alignment between base and mask video segments. The container metadata includes structural information embedded in a video container format that defines frame dimensions, codec type, frame rate, orientation of stitched segments, and timing parameters. The container metadata enables correct identification and interpretation of the base video segment and the mask video segment boundaries within each frame. The frame indices are sequential identifiers assigned to individual frames within a video stream that preserve temporal ordering during decoding and playback. The frame indices ensure that base video segment and the mask video segments encoded within the same frame remain synchronized during decoding, seeking, and buffering.

In one embodiment, the stitched video uses an industry-standard codec such as H.264 or H.265 within a container format such as MP4. The use of such encoding formats ensures compatibility with hardware decoders that do not support alpha channel processing. The receiving module 108a decodes the stitched video as a single stream without requiring multi-stream synchronization or additional decoding hardware. The single stream decoding is enabled by embedding the base and mask data within a single encoded file.

The receiving module 108a manages frame buffering and sequence control to maintain uninterrupted playback. The receiving module 108a stores incoming video frames in the intelligent frame buffer to handle network latency or bandwidth variations during streaming. Accordingly, the receiving module 108a forwards the buffered frames sequentially to the decoding module 108b for further processing. The buffering mechanism prevents frame loss or timing mismatches and ensures that each frame reaches the decoding stage in the correct order with complete base and mask data.

The base segment and the mask segment are encoded within the same frame of the stitched video, enabling random-access operations. Example of such operation can be, seeking a specific frame to return both color and mask data simultaneously. The configuration ensures that frame-accurate seeking and scrubber operations remain synchronized for the color and the transparency data without requiring additional multi-stream seek coordination. The receiving module 108a verifies the integrity of the received frames through checksum validation or frame-index tracking to detect missing or corrupted frames. When the receiving module 108a detects an irregularity, a request for retransmission of the affected segments or interpolates missing frames is sent to maintain playback continuity. The structured delivery of stitched frames enables the decoding module 108b and the shader module 108c to extract luminance-based transparency information with frame-level precision.

The decoding module 108b is configured to execute the second step of the method or the process. The decoding module 108b decodes the stitched video received from the receiving module 108a to separate luminance-based transparency data from the visual color data in each frame. The decoding module 108b uses a native hardware or software decoder of the communication device 104 to process the stitched video as a single unified stream. The decoding module 108b identifies two distinct data regions. The data regions include a base video region and a mask video region. The base video region contains RGB color information. The mask video region contains grayscale pixel-intensity values. The grayscale pixel-intensity values mapped on a per-pixel basis to transparency coefficients.

Each grayscale pixel-intensity value represents a luminance-derived alpha value that defines an opacity level to be applied to a corresponding RGB pixel in the base video region during generation of a blended output frame. Each pixel intensity encodes a corresponding transparency coefficient for a spatially aligned pixel location in the base video region. Lower grayscale values indicate higher transparency. Higher grayscale values indicate higher opacity during subsequent alpha extraction and compositing operations. In an embodiment of the present disclosure, grayscale intensity values in the mask video region range from 0 to 255. A value of 0 represents full transparency, a value of 255 represents full opacity, and intermediate values represent proportional transparency levels applied during the pixel-level compositing.

The single-decoder configuration eliminates the requirement for multiple synchronized video streams and ensures frame-accurate alignment between the RGB data and the transparency data. The decoding module 108b interprets positional metadata embedded within the stitched video stream to identify the data regions within each decoded frame. The orientation of the data segments, either top-down or left-right, is determined dynamically based on encoding parameters received from the receiving module 108a.

During operation, the decoding module 108b separates the raw pixel data of each frame into the base region and the mask region and maintains pixel-level alignment. Each pixel in the mask region directly corresponds to a specific pixel location in the base region, which ensures that the transparency data extracted in later processing stages aligns precisely with associated color data. The arrangement maintains frame-accurate synchronization and prevents temporal or spatial drift between the color and transparency layers.

The decoding module 108b supports the stitched video streams encoded with standard codecs such as H.264 or H.265 within container formats such as MP4. The formats allow decoding through native hardware decoders available on most consumer devices. By using existing hardware decoding capabilities, the decoding module 108b ensures compatibility with devices that do not support alpha channel decoding. In addition, the decoding module 108b enables transparent video playback without changes to the decoder architecture. The frame data resides in an intermediate frame buffer or the intelligent frame buffer after the decoding. The color data and the luminance data occupy synchronized memory regions. The buffering process supports parallel frame processing and maintains a continuous data pipeline to the shader module 108c. The decoding module 108b processes the buffered frames sequentially to preserve frame order and prevent visual discontinuities during playback.

In an embodiment, the decoding module 108b executes error detection and correction mechanisms to ensure reliable frame reconstruction. The decoding module 108b verifies frame sequence indices or performs checksum validation to detect missing or corrupted frames. When inconsistencies appear, the decoding module 108b applies predictive interpolation or requests retransmission of missing data packets from the receiving module 108a to maintain visual continuity.

In an embodiment, the decoding module 108b outputs decoded data in a GPU-readable format such as YUV, NV12, or RGBA, depending on the hardware capabilities of the communication device 104. The decoding module 108b directs the decoded base region and the decoded mask region to GPU memory. The close integration between the decoder and GPU minimizes data transfer latency and improves frame throughput. The decoding module 108b operates under real-time constraints to complete decoding and data transfer within the frame duration defined by the playback frame rate between 24 and 60 frames per second. The low-latency decoding pipeline allows the system 108 to render transparency effects as frames are decoded. The decoding ensures smooth playback of stitched videos that include alpha information.

The shader module 108c performs the third step of the method or the process. The shader module 108c extracts alpha values corresponding to pixel intensity from the mask video segment. The shader module 108c executes GPU-accelerated fragment shaders to map luminance to normalized alpha values in the range 0 to 1. In an embodiment, the shader module 108 c performs real-time conversion using programmable pipelines such as OpenGL or Vulkan or equivalent GPU pipelines to interpret luminance values in the mask region. Accordingly, the shader module 108c translates the luminance values into normalized alpha data representing pixel transparency levels. The shader module 108c converts the luminance values in the mask region into normalized alpha coefficients ranging from 0.0 (fully transparent) to 1.0 (fully opaque). In addition, the shader module 108c performs per-pixel computation in parallel using the graphics processing unit to achieve real-time transparency extraction. The extracted alpha data remain synchronized with the base color data to maintain pixel-level alignment throughout each frame. Programmable GPU shaders perform the conversion in real time by mapping pixel intensity to alpha through a linear or gamma-corrected transformation function.

The shader module 108c performs transparency extraction in parallel across all pixels in each frame by using the parallel computing architecture of the GPU. The parallelized computation reduces processing latency and ensures that transparency extraction occurs within the same temporal window as frame decoding. The combination of hardware decoding by the decoding module 108b and the GPU-based processing by the shader module 108c enables the system 108 to achieve real-time transparency rendering. The transparency rendering is achieved at playback frame rates between 24 and 60 frames per second.

The shader module 108c retains the extracted alpha data in a temporary GPU buffer associated with the corresponding base video region decoded from the same frame. Also, the shader module 108c maintains pixel-level correspondence between each alpha value and respective color pixel coordinates to preserve spatial accuracy and prevent edge misalignment during compositing. The shader module 108c applies sub-pixel interpolation to smooth transitions between adjacent transparency levels and to eliminate visual artifacts such as banding or hard edges. The shader module 108c employs hardware-level precision using floating-point arithmetic to achieve accurate luminance-to-alpha conversion in high-dynamic-range content. The use of high-precision computation ensures that fine transparency gradients such as shadows, reflections, and semi-transparent textures render accurately without color distortion or quantization error.

In one embodiment, the system 108 implements the intelligent frame buffer as a distinct functional element that temporarily stores paired RGB and alpha datasets for one or more frames before compositing. The intelligent frame buffer retains the decoded base region and the corresponding extracted alpha region until both data components become available. The intelligent frame buffer delivers complete RGBA frames to the compositing module 108d in atomic form. The intelligent frame buffer performs temporal smoothing, missing-data estimation, and priority-based eviction to ensure timely delivery of paired frames to the GPU compositing pipeline while maintaining a minimal memory footprint

The shader module 108c supports configurable transparency profiles that define how luminance values correspond to alpha values. The shader module 108c applies mapping modes such as inverted luminance mapping or custom transfer functions for specific content types based on metadata embedded within the stitched video or parameters received from the receiving module 108a. The configurability allows content creators to define transparency behavior according to encoding strategy or visual design requirements.

The shader module 108c includes error mitigation mechanisms to address inconsistencies in the decoded mask data. When luminance values are missing, corrupted, or clipped due to compression artifacts, the shader module 108c estimates corresponding alpha values through temporal interpolation or spatial averaging techniques derived from adjacent frames or neighboring pixel clusters. The error mitigation maintains continuity of transparency effects and prevents visible flicker or discontinuity in the rendered output.

After extracting and validating alpha values, the shader module 108c transmits the combined RGB data and the alpha data to the compositing module 108d for blending with the base video frame. The shader module 108c stores the alpha data in GPU memory buffers optimized for real-time rendering to enable compositing operations with minimal data transfer latency.

The shader module 108c operates in coordination with the optimization module 108f. The optimization module 108f dynamically adjusts the shader execution parameters according to GPU load and available processing bandwidth of the communication device 104. The adaptive control maintains efficient transparency extraction under variable computational conditions and preserves frame rate stability while minimizing power consumption.

The compositing module 108d performs the fourth step of the method or the process. The compositing module 108d applies the extracted alpha values to the corresponding pixels in the base video segment to generate a final blended frame.

The compositing module 108d applies the alpha values to the corresponding base video segment to generate the final blended frame for display. The compositing module 108d performs real-time blending of the base video data and the mask video data. Accordingly, the compositing module 108d ensures accurate rendering of the pixel-level transparency as defined in the stitched video content.

Each frame received by the compositing module 108d contains synchronized data sets. One data set represents the RGB color components of the base video, and another data set represents the luminance-derived alpha coefficients obtained from the shader module 108c. The compositing module 108d uses the alpha coefficients to determine the visibility of each pixel relative to the display background or visual environment. The compositing module 108d generates the blended result through a pixel-by-pixel compositing operation using a weighted averaging function based on the corresponding alpha value.

The compositing module 108d maintains spatial alignment between the base video segment and the mask video segment by referencing the coordinate mapping used during decoding. The compositing module 108d ensures that each alpha value corresponds exactly to its associated RGB pixel. The spatial alignment prevents rendering defects such as edge halos, shadow misalignments, or mismatched transparency regions that could degrade visual quality. In an embodiment, the compositing module 108d integrates a sub-pixel correction algorithm to enhance blending precision. The algorithm compensates for interpolation effects and fractional pixel offsets that occur during decoding or scaling operations. By accounting for sub-pixel variations, the compositing module 108d ensures consistent edge fidelity and smooth transitions across semi-transparent boundaries. Further, the compositing module 108d performs dynamic context-aware blending. A transparency intensity adjusts in real time based on environmental conditions, lighting variations, or user interactions. In a mixed-reality environment, the compositing module 108d modifies alpha weighting to balance contrast and brightness between virtual video elements and live background imagery to achieve natural visual integration.

In an embodiment, the compositing module 108d supports multiple blending modes beyond standard linear interpolation. Supported modes include pre-multiplied alpha, additive blending, and screen blending. The compositing module 108d selects the blending mode based on the metadata embedded in the stitched video or based on instructions received from the optimization module 108f. The optimization module 108f dynamically determines the appropriate mode according to rendering context and device performance.

The compositing module 108d maintains temporal coherence during continuous playback through frame synchronization and buffer management. The compositing module 108d employs double-buffering or triple-buffering techniques to prepare new composited frames while previously rendered frames display on screen, preventing tearing or flickering during rapid motion sequences.

In another embodiment, the compositing module 108d integrates the blended output with real-world imagery captured by the one or more sensors 104a of the communication device 104, such as a camera feed. The compositing module 108d combines the decoded and the transparency-applied video data with live visual input to produce augmented or mixed-reality visualization. The compositing module 108d aligns digital and physical elements by referencing orientation and pose data from the device sensors to maintain accurate placement of visual components within the user's field of view. In addition, the compositing module 108d manages color consistency and gamma correction between the blended video content and the display environment. The compositing module 108d applies post-processing adjustments such as tone mapping and contrast normalization to ensure visual coherence under varying lighting conditions or display characteristics.

After completing the blending operation, the compositing module 108d transmits the final composited frame to the display module 108e for presentation. The compositing module 108d outputs composited frames in GPU-compatible formats such as RGBA to minimize data transfer latency between GPU memory and display output. The efficient data transfer enables the system 108 to maintain high frame rates and real-time transparency rendering performance. The compositing module 108d provides the functional interface between alpha extraction and visual output generation. The compositing module 108d ensures accurate and efficient application of the transparency information to video content.

The display module 108e performs the fifth step of the method or the process. The method includes displaying the final blended frame on the communication device 104 in real time. The display module 108e displays the final blended frame on the display interface of the communication device 104. The display module 108e retrieves the blended frame from the GPU memory and renders the frame on the device display surface. The display module 108e maintains synchronization with the display refresh rate to ensure smooth playback.

In certain embodiments, the display module 108e renders the blended frame over a live camera feed or sensor-captured environment to enable augmented reality or mixed reality visualization. The display module 108e ensures that the transparency-rendered video integrates naturally with real-world imagery with high visual fidelity and minimal latency. The display module 108e adapts brightness and contrast based on ambient lighting data obtained from the one or more sensors 104a to preserve visual fidelity in augmented-reality conditions.

The display module 108e interfaces directly with the graphics subsystem of the communication device 104, such as the GPU frame buffer or display controller, to retrieve composited frames stored in GPU memory. The display module 108e handles continuous rendering of frames at playback rates typically ranging from 24 to 60 frames per second or higher based on device performance. The display module 108e synchronizes the rendering pipeline with the display refresh rate to prevent visual artifacts such as tearing, ghosting, or dropped frames. The display module 108e manages the presentation queue for composited frames by employing double-buffering or triple-buffering techniques. The buffering process prepares the next frame while the current frame displays to ensure seamless playback and correct temporal sequencing of transparency-rendered frames without latency or jitter.

In an embodiment, the display module 108e overlays composited frames directly on real-world imagery captured by sensors of the communication device 104, such as a camera or depth sensor. The display module 108e enables the system 108 to operate in augmented reality or mixed reality environments where transparent video content merges with live environmental scenes. The display module 108e references positional, orientation, and depth data from device sensors to maintain spatial alignment of rendered video elements within the user's view during device movement.

The display module 108e performs dynamic scene adaptation by adjusting brightness, contrast, and transparency intensity of composited frames according to ambient lighting and background color detected by the communication device 104 sensors. The display module 108e maintains consistent visual perception of transparency effects under varying environmental conditions. For example, when ambient lighting is bright, the display module 108e increases opacity values to preserve contrast, and under darker conditions, the display module 108e increases transparency levels to maintain natural balance.

The display module 108e supports rendering of final frames on multiple display surfaces, including flat-panel displays, mobile device screens, head-mounted visors, holographic projection surfaces, and extended-reality interfaces. The display module 108e optimizes rendering resolution according to the target display's pixel density, refresh rate, and aspect ratio to preserve sharpness and prevent distortion of transparency effects across output devices.

In another embodiment, the display module 108e includes a color management subsystem that maintains visual consistency between composited frames and the display environment. The color management subsystem performs gamma correction, tone mapping, and color-space conversions such as YUV to sRGB or Rec. 709 to ensure accurate color reproduction. The color management subsystem prevents color distortion and maintains perceptual realism of transparency-rendered content.

The display module 108e coordinates with the optimization module 108f to dynamically adapt rendering frame rate and resolution based on real-time performance metrics. When GPU utilization exceeds a threshold, the optimization module 108f instructs the display module 108e to lower resolution or reduce frame rate to maintain stable playback without reducing transparency quality. When processing capacity increases, the display module 108e restores native playback resolution and frame rate for maximum visual fidelity.

In an embodiment, the display module 108e supports low-latency rendering pipelines for interactive applications such as real-time augmented reality visualization and gaming. The display module 108e minimizes latency between compositing and display, providing immediate visual feedback in response to user actions or environmental changes. The low-latency configuration enhances immersion and responsiveness in interactive use cases.

In an embodiment, the display module 108e includes error handling and fallback mechanisms to maintain continuous playback during display interruptions or frame inconsistencies. When a composited frame fails to meet synchronization timing, the display module 108e redisplays the previous frame or interpolates transitional frames using temporal blending to prevent flicker or discontinuity in visual output.

In another embodiment, the display module 108e records or streams rendered output for broadcasting, augmented reality live streaming, or digital production workflows. The display module 108e encodes rendered transparency content in standard video formats such as MP4 or WebM to enable transmission or storage without visual degradation.

Through this configuration, the display module 108e delivers high-fidelity visualization of transparency-rendered video frames with accurate synchronization, adaptive brightness control, and color consistency. The display module 108e integrates with device sensors and display hardware to project composited video content in real time within both digital and physical environments. The display module 108e enables natural and immersive transparency rendering for augmented, mixed, and extended reality applications.

The stitched encoding approach increases the encoded frame pixel area because each encoded frame contains both the base region and the mask region. Each stitched-encoded frame includes approximately twice the pixel count of a single-channel frame that carries only color data. As a result, the effective display resolution of the base content becomes approximately half of the encoded frame resolution. This tradeoff affects low-end devices and devices with strict maximum decode resolutions. The optimization module 108f monitors device decoding limits and selects adaptive downscaling, alternate encoding formats such as native-alpha streams, or lower playback resolutions to maintain compatibility and visual fidelity.

The method concludes when the system 108 generates and displays the final blended frame. The final blended frame represents a composite of the decoded RGB data, the extracted alpha transparency data, and environmental background information. The method repeats continuously for every frame in the video sequence to achieve real-time rendering of the transparency-encoded video content.

Through the sequence of steps illustrated in FIG. 1B, the method establishes the single-decoder, GPU-accelerated framework for decoding and rendering the transparency information. By processing the base data and the mask data within the single stitched video stream, the method ensures pixel-level synchronization, minimizes computational overhead, and enhances rendering efficiency. The method supports smooth playback of transparency-enhanced video content for applications including augmented reality, interactive media, gaming, and immersive visualization environments.

The optimization module 108f manages and regulates the overall performance of system 108 during the real-time decoding and rendering of the stitched video content. The optimization module 108f ensures stable playback, efficient resource utilization, and consistent visual quality across devices with varying computational capabilities and under changing network conditions. The optimization module 108f dynamically adjusts parameters such as resolution, bitrate, frame buffering, and GPU workload distribution to maintain high-quality transparency rendering without frame loss, stuttering, or synchronization drift.

The optimization module 108f monitors system performance indicators including GPU utilization, CPU load, available memory, decoding throughput, and network bandwidth. The optimization module 108f analyzes these parameters in real time to evaluate playback conditions and determine whether the active rendering configuration aligns with device performance limits and network stability. Based on the analysis, the optimization module 108f applies adaptive control mechanisms to balance computational efficiency and visual fidelity.

In one embodiment, the optimization module 108f performs adaptive resolution scaling to adjust playback resolution according to device processing power and display capacity. When the system detects limited GPU availability or increased frame latency, the optimization module 108f reduces playback resolution to maintain smooth rendering. When sufficient processing resources are available, the optimization module 108f restores native resolution to achieve full visual quality.

The optimization module 108f manages adaptive bitrate control to stabilize playback under variable network bandwidth conditions. During streaming, when network throughput decreases below a threshold, the optimization module 108f requests lower bitrate segments from the content server to ensure uninterrupted playback. When network capacity increases, the optimization module 108f retrieves higher bitrate segments to restore full-quality video rendering. The adaptive bitrate strategy preserves transparency fidelity and playback smoothness across network conditions.

In certain embodiments, the optimization module 108f interfaces with the receiving module 108a to synchronize bitrate adjustments with frame buffering operations. The optimization module 108f allocates buffer space dynamically based on real-time network behavior to prevent buffer underflow or overflow during data reception. The coordinated management ensures consistent frame delivery to the decoding module 108b even during temporary bandwidth fluctuations.

The optimization module 108f regulates memory utilization during playback to prevent excessive consumption and to maintain continuous frame processing. The optimization module 108f ensures that decoded frames stored in temporary buffers are released promptly after rendering by the display module 108e. The optimization module 108f implements a memory recycling mechanism that maintains a fixed buffer size and prevents resource congestion during extended playback sessions.

In one embodiment, the optimization module 108f coordinates with the shader module 108c to balance GPU workload dynamically. When shader processing demand increases due to high-resolution or high-frame-rate content, the optimization module 108f adjusts shader execution frequency, modifies sampling density, or applies simplified luminance-to-alpha conversion models to maintain real-time performance. When GPU utilization decreases, the optimization module 108f restores full-resolution shader operations to preserve transparency accuracy.

The optimization module 108f controls frame rate adaptation to synchronize video playback frame rate with the display refresh rate of the communication device 104. When system resources become limited, the optimization module 108f temporarily reduces frame output to maintain synchronization and prevent playback jitter. When system performance improves, the optimization module 108f resumes full frame rate rendering for maximum visual fluidity.

In another embodiment, the optimization module 108f performs error recovery and fallback operations to maintain stable transparency rendering during frame loss, corruption, or decoding failure. When incomplete or invalid frames are detected, the optimization module 108f activates predictive interpolation algorithms that estimate missing transparency or color data based on adjacent frames. The corrective mechanism minimizes visual disturbance and ensures continuous playback consistency.

The optimization module 108f incorporates thermal and power management for mobile devices. The optimization module 108f monitors device temperature and power consumption and scales GPU-intensive operations such as shader execution or high-resolution rendering when thermal thresholds approach operational limits. The power management control prevents throttling and supports sustained real-time playback.

In one embodiment, the optimization module 108f communicates with a cloud-based performance management system or a remote configuration server that provides device-specific optimization parameters. The external configuration enables consistent playback performance across different hardware platforms, display resolutions, and network environments.

The optimization module 108f operates in coordination with all functional modules of system 108. The optimization module 108f provides feedback to the receiving module 108a for data intake management, to the decoding module 108b for frame throughput control, to the shader module 108c for GPU load balancing, and to the display module 108e for synchronized frame presentation. The closed-loop control framework ensures that all subsystems operate within their respective performance limits in a harmonized manner.

Through adaptive, real-time optimization mechanisms, the optimization module 108f maintains transparency fidelity, consistent frame rendering, and efficient resource utilization across diverse operating environments. The optimization module 108f enables system 108 to respond dynamically to variations in processing resources and external network conditions. At the same time, the optimization module 108f preserves visual quality and timing precision required for seamless transparency rendering in applications. Examples of the applications include augmented reality, interactive media, immersive visualization, and mixed-reality environments.

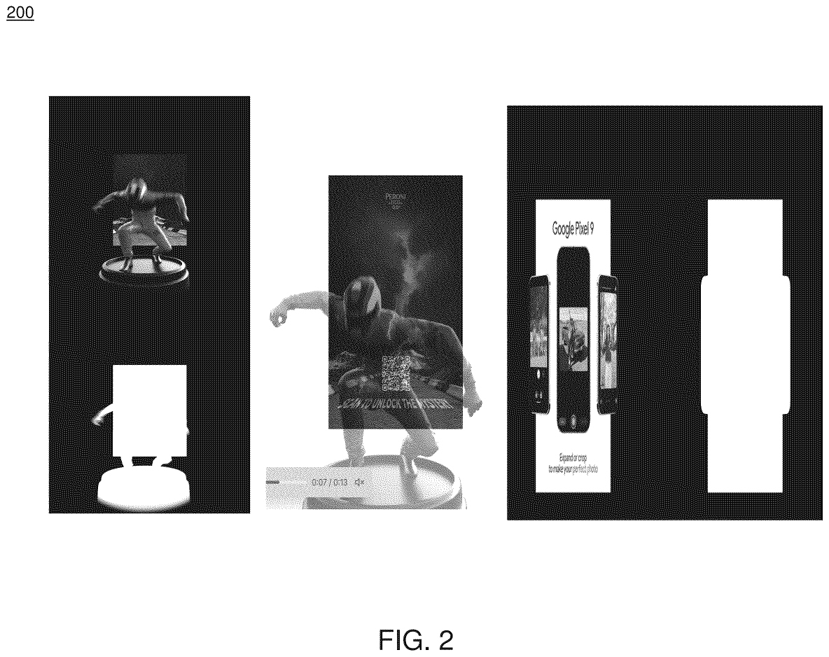

FIG. 2 illustrates an exemplary frame and configurations representing progressive transformation of the stitched video content into the final blended output, in accordance with embodiments of the present disclosure. The sequence of the visual frames 200 are processed by the system 108 for the single-decoder stitched-video transparency rendering. The left illustration shows a top-down configuration of a base video and a mask video. The middle illustration shows a final render of a frame. The rightmost illustration a left-right configuration of the base video and the mask.

The illustrated sequence demonstrates the progressive transformation of stitched base and mask video segments into the real-time transparency-rendered composite. The upper portion of each configuration depicts the base video frame containing the primary RGB visual content, while the lower portion depicts the corresponding luminance-based mask segment encoding pixel-level transparency data. During processing, the decoding module 108b separates the base and mask regions, and the shader module 108c interprets luminance values within the mask as alpha coefficients through GPU-accelerated fragment operations. The compositing module 108d blends the alpha data with the decoded base content to generate the final RGBA frame. The middle illustration exemplifies the output after shader processing and alpha application, showing accurate transparency blending of digital elements with environmental visuals. The sequence collectively represents intermediate visualization stages within the GPU shader and compositing pipeline of the system 108. The sequence demonstrates how the single-decoder architecture maintains pixel alignment, temporal synchronization, and transparency accuracy across both top-down and left-right stitched configurations.

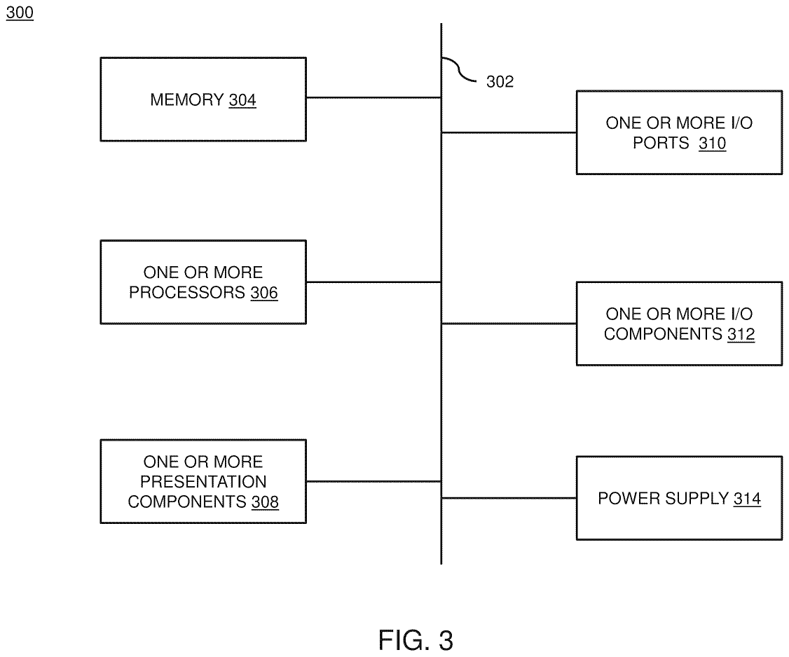

FIG. 3 illustrates a block diagram of a device 300, in accordance with various embodiments of the present disclosure. The device 300 is a non-transitory computer-readable storage medium. The device 400 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more buses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art and reiterate that the diagram of FIG. 3 is merely illustrative of an exemplary device 300 that can be used in connection with one or more embodiments of the present disclosure. Distinction is not made between such categories as “workstation,” “server,” “laptop,” “hand-held device,” etc., as all are contemplated within the scope of FIG. 3 and reference to “device.”

The device 300 typically includes a variety of computer-readable media. The computer-readable media can be any available media that can be accessed by the device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The device 300 includes the one or more processors 306 that read data from various entities such as memory 304 or I/O components 312. The one or more presentation components 308 present data indications to a user or other device. Exemplary presentation components include a display device, speaker, printing component, vibrating component, etc. The one or more I/O ports 310 allow the device 300 to be logically coupled to other devices including the one or more I/O components 312, some of which may be built in. Illustrative components include a microphone, joystick, game pad, satellite dish, scanner, printer, wireless device, etc.

In embodiments of the present disclosure, the invention produces a series of concrete technical effects at the decoder, GPU, and frame-buffer levels of a communication device. The stitched video architecture transforms two logically separate signal domains (color and transparency) into a single hardware-decodable video stream for eliminating the need for multi-stream synchronization at the decoding layer. This reduces decoder thread overhead, removes inter-stream timestamp arbitration, and lowers CPU scheduling latency. Further, the invention improves native hardware decoder utilization by encoding the base data and the mask data within a single container format compatible with standard hardware decoders (e.g., H.264, H.265). Accordingly, the present invention produces a measurable reduction in decoder pipeline switching and avoids the computational penalties associated with multi-stream arbitration. In addition, the invention enables deterministic pixel-level alignment between the RGB data and the luminance-based mask data within the same decoded frame memory region. The alignment prevents temporal drift and eliminates cross-frame transparency mismatch errors that occur in dual-stream approaches. Moreover, the GPU-resident shader processing transforms the luminance intensity values into normalized alpha coefficients in parallel using fragment execution pipelines. Accordingly, the invention enables creation of the direct signal transformation at the pixel level, converting grayscale image data into opacity-weighted rendering coefficients in real time. Furthermore, the system retains the base segment and the mask segment within the same frame structure. Accordingly, the system of the present invention enables frame-accurate random access, seek operations, and scrubber synchronization without cross-stream reconciliation logic. This improves decoder seek determinism and reduces jitter artifacts during playback. Also, the adaptive resolution scaling and the GPU load regulation produce real-time dynamic control over frame throughput to prevent decoder saturation on heterogeneous mobile devices. The optimization module modifies resolution, bitrate selection, shader execution density, and buffer recycling policies to maintain steady frame cadence. The memory recycling and controlled frame eviction reduce peak memory pressure during sustained playback for preventing buffer overflow and avoiding OS-level throttling on constrained devices. The above discussed technical effects are realized through architectural modifications to the video decoding pipeline, GPU compositing layer, memory buffer management system, and metadata interpretation mechanisms of the communication device.

The present invention provides significant advantages over conventional video decoding and rendering systems, particularly in applications requiring real-time transparency rendering, resource efficiency, and device compatibility. One major advantage is the single-decoder architecture, which processes both base and mask data from a single stitched video stream. This configuration eliminates the need for multiple synchronized decoding pipelines, thereby reducing computational complexity, power consumption, and synchronization errors. Another advantage is the implementation of a GPU-accelerated shader module that performs real-time extraction and conversion of luminance-based transparency data into alpha values. The GPU-based operation enhances rendering speed and enables smooth playback of transparency-encoded video content, even on devices with limited native alpha-channel support.

In one advantage, the compositing module blends decoded color data and extracted alpha data at the pixel level, producing visually seamless integration of transparent and opaque regions. The resulting output achieves high visual fidelity and accurate transparency alignment, essential for augmented and mixed-reality applications.

Another advantage of the invention is the inclusion of the optimization module, which dynamically regulates resolution, bitrate, and rendering parameters according to available system resources and network conditions. This adaptive mechanism maintains transparency quality and stable playback performance across heterogeneous hardware platforms.

An additional advantage lies in the system's ability to operate using existing video standards and hardware decoders. By encoding base and mask data within a single stitched video file, the system achieves full compatibility with widely supported formats such as MP4, H.264, and HEVC, removing the need for specialized alpha-channel hardware or proprietary codecs.

The system supports integration with environmental or camera-captured backgrounds, enabling real-time compositing of digital and physical elements for augmented, mixed, and extended reality visualizations. The combination of real-time performance, synchronization precision, and efficient hardware utilization provides a robust and scalable solution for transparency rendering across various multimedia and immersive content applications.

The foregoing descriptions of specific embodiments of the present technology have been presented for the purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the disclosure have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A system for decoding and rendering transparency information from stitched video content on a communication device; the system comprising:
a receiving module configured to receive a stitched video containing a base video segment and a mask video segment arranged in a pre-determined orientation;
a decoding module configured to decode the stitched video as a single unified stream and to separate luminance-based transparency data associated with the mask video segment from visual color data associated with the base video segment;
a shader module configured to extract, on a per-pixel basis, alpha values corresponding to grayscale intensity values of the mask video segment;
a compositing module (configured to apply the extracted alpha values to spatially corresponding pixels of the base video segment to generate a final blended frame; and
a display module configured to display the final blended frame on the communication device in real time.

2. The system of claim 1, wherein the stitched composite video is encoded in a standard video container format supporting single-stream decoding selected from MP4, HEVC, or WebM to enable the decoding of the base video segment and the mask video segment decoded using a native hardware decoder of the communication device.

3. The system of claim 1, wherein the stitched video is arranged in a top-down or left-right configuration, wherein the configuration enables each pixel of the base video segment to maintain pixel-level correspondence with a luminance-defining pixel of the mask video segment within the same decoded frame.

4. The system of claim 1, wherein the shader module executes a GPU-accelerated shader pipeline comprising at least one OpenGL shader or equivalent programmable graphics shader to convert grayscale luminance values into normalized alpha coefficients in real time.

5. The system of claim 1, wherein the compositing module performs GPU-accelerated per-pixel alpha blending using parallel fragment execution and sub-pixel correction to preserve edge fidelity and transparency gradients within the final blended frame.

6. The system of claim 1, wherein the display module overlays the final blended frame onto a background scene captured by one or more sensors of the communication device to enable rendering within an augmented-reality or mixed-reality environment.

7. The system of claim 1, further comprising an optimization module configured to dynamically regulate at least one of decoding throughput, GPU utilization, playback resolution, or frame rate to maintain real-time transparency rendering across heterogeneous device capabilities and network conditions.

8. The system of claim 1, further comprising a repository configured to store at least one of adaptive bitrate parameters, frame buffering rules, or playback optimization instructions, wherein the repository being accessed by the receiving module to minimize frame-latency drift between the base video segment and the mask video segment.

9. The system of claim 1, wherein the system generates and processes metadata describing alpha-map boundaries, segment orientation, and pixel correspondence, and uses the metadata to enable at least one of selective region-based decoding, compression optimization, or error-resilient transparency rendering.

10. A computer-implemented method for decoding and rendering transparency information from stitched video content on a communication device, the computer-implemented method comprising:
receiving, by a receiving module, a stitched video comprising a base video segment and a mask video segment arranged in a pre-determined orientation;
decoding, by a decoding module, the stitched video as a single unified stream and separate luminance-based transparency data associated with the mask video segment from visual color data associated with the base video segment;
extracting, by a shader module, on a per-pixel basis, alpha values corresponding to grayscale intensity values of the mask video segment applying, by a compositing module, the extracted alpha values to spatially corresponding pixels to the base video segment to generate a final blended frame; and
displaying, by a display module, the final blended frame on the communication device in real time.

11. The computer-implemented method of claim 10, wherein the stitched video is encoded in a standard video container format supporting single-stream decoding selected from MP4, HEVC, or WebM to enable decoding of the base video segment and the mask video segment using a native hardware decoder of the communication device.

12. The computer-implemented method of claim 10, wherein the stitched video is arranged in a top-down or left-right configuration, wherein the configuration enables each pixel of the base video segment to maintain pixel-level correspondence with a luminance-defining pixel of the mask video segment within the same decoded frame.

13. The computer-implemented method of claim 10, wherein to je extraction of the alpha values comprises executing a GPU-accelerated shader pipeline, wherein the GPU-accelerated shader pipeline comprises at least one OpenGL shader or equivalent programmable graphics shader to convert grayscale luminance values into normalized alpha coefficients in real time.

14. The computer-implemented method of claim 10, wherein the applying of the extracted alpha values comprises performing GPU-accelerated per-pixel alpha blending using parallel fragment execution and sub-pixel correction to preserve edge fidelity and transparency gradients within the final blended frame.

15. The computer-implemented method of claim 10, wherein the displaying of the final blended frame comprises overlaying the final blended frame onto a background scene captured by one or more sensors of the communication device to enable rendering within an augmented-reality or mixed-reality environment.

16. The computer-implemented method of claim 10, further comprising dynamically regulating, by an optimization module, at least one of decoding throughput, GPU utilization, playback resolution, or frame rate to maintain real-time transparency rendering across heterogeneous device capabilities and network conditions.

17. The computer-implemented method of claim 10, further comprising accessing, from a repository, at least one of adaptive bitrate parameters, frame buffering rules, or playback optimization instructions to minimize frame-latency drift between the base video segment and the mask video segment.

18. The computer-implemented method of claim 10, further comprising generating and processing metadata describing at least alpha-map boundaries, segment orientation, and pixel correspondence, and using the metadata to enable at least one of selective region-based decoding, compression optimization, or error-resilient transparency rendering.

19. A non-transitory computer-readable storage medium storing instructions that, when executed by one or more processors of a communication device, cause the communication device to perform a method comprising:
receiving a stitched video comprising a base video segment and a mask video segment arranged in a pre-determined orientation;
decoding the stitched video as a single unified stream to obtain decoded frame data comprises visual color data and luminance-based transparency data;
extracting alpha values corresponding to grayscale pixel intensity of the mask video segment;
applying the extracted alpha values to spatially aligned pixels of the base video segment to generate a final blended frame; and
displaying the final blended frame in real time on the communication device.

20. The non-transitory computer-readable storage medium of claim 19, wherein the instructions further cause generation and processing of metadata defining alpha-map boundaries and segment orientation to enable selective region-based decoding or error-resilient rendering.
